(19) United States
(12) Patent Application Publication
(10) Pub. No.: US 2014/0194161 A1
(43) Pub. Date: Jul. 10, 2014

(54) APPARATUS FOR MANIPULATING A MOBILE TERMINAL DEVICE

(71) Applicant: O2Micro Inc., Santa Clara, CA (US)

(72) Inventors: Sterling DU, Shanghai (CN); Jing CHEN, Wuhan (CN); Xinsheng PENG, Wuhan (CN); Yating LI, Wuhan (CN); Yang WANG, Wuhan (CN)

(73) Assignee: O2Micro Inc., Santa Clara, CA (US)

(21) Appl. No.: 14/140,186

(22) Filed: Dec. 24, 2013

(30) Foreign Application Priority Data
Jan. 7, 2013 (CN) 201310005309.5

(51) Int. Cl. H04M 1/725

(52) U.S. Cl. CPC H04M 1/72527
USPC 455/557

(57) ABSTRACT

An apparatus includes an operation input unit, a detecting unit, a signal generator, and an interface unit. The operation input unit includes one or more actionable areas or buttons configured to be operated by a user. The detecting unit is coupled to the operation input unit and configured to detect an operation performed by the user in one of the actionable areas to provide a detected operation. The signal generator is coupled to the detecting unit and configured to generate a control signal according to the detected operation. The interface unit is coupled to the signal generator and configured to transfer the control signal to a mobile terminal device that is structurally coupled to the apparatus.

### RELATED APPLICATIONS

This application claims priority to Patent Application No. 201310005309.5, filed on Jan. 7, 2013, with the State Intellectual Property Office of the People's Republic of China, incorporated by reference in its entirety herein.

### BACKGROUND

With the development of technology in mobile terminal devices such as cell phones, people tend to use these mobile terminal devices to achieve various functions, e.g., photography, lighting, etc. The “self-portrait-photograph” function of a cell phone with a touch screen/panel is particularly popular among users. However, it can be inconvenient for a user to use such cell phone to “self-portrait-photograph” because the user's arm or hand which holds the cell phone can be accidentally captured by the camera of the cell phone. In addition, when using such cell phone for lighting, it can be difficult for a user to find a locus, e.g., a proper angle and position, to hold or place the cell phone to achieve an expected lighting effect. It can also be inconvenient for the user to change camera settings, e.g., zoom in or zoom out, during self-portrait-photography.

Therefore, there is a need for an apparatus and a method for controlling a mobile terminal device by the apparatus, to avoid the above drawbacks and inconveniences during self-portrait-photography.

### SUMMARY

In an embodiment, an apparatus includes an operation input unit, a detecting unit, a signal generator, and an interface unit. The operation input unit includes one or more actionable areas or buttons configured to be operated by a user. The detecting unit is coupled to the operation input unit and configured to detect an operation performed by the user in one of the actionable areas to provide a detected operation. The signal generator is coupled to the detecting unit and configured to generate a control signal according to the detected result. The interface unit is coupled to the signal generator and configured to transfer the control signal to a mobile terminal device that is structurally coupled to the apparatus.

In another embodiment, a method is disclosed for using an apparatus to control a mobile terminal device that is structurally coupled to the apparatus. In response to an operation performed by a user in one of multiple actionable areas on the apparatus, the apparatus transfers a control signal to the mobile terminal device. The control signal is monitored by the mobile terminal device. It is determined by the mobile terminal device which operation is performed by the user according to the control signal to provide a determined operation. The mobile terminal device is then controlled based on the determined operation.

Additional benefits and novel features will be set forth in part in the description which follows, and in part will become apparent to those skilled in the art upon examination of the following and the accompanying drawings or may be learned by production or operation of the disclosed embodiments. The benefits of the present embodiments may be realized and attained by practice or use of various aspects of the methodologies, instrumentalities and combinations set forth in the detailed description set forth below.

### BRIEF DESCRIPTION OF THE DRAWINGS

Features and benefits of embodiments of the claimed subject matter will become apparent as the following detailed description proceeds, and upon reference to the drawings, wherein like numerals depict like parts. These exemplary embodiments are described in detail with reference to the drawings. These embodiments are non-limiting exemplary embodiments, in which like reference numerals represent similar structures throughout the several views of the drawings.

FIG. 1 illustrates a block diagram of an example of an auxiliary operation device, in accordance with an embodiment of the present teaching;

FIG. 2A illustrates a structural diagram of an example of an auxiliary operation device cooperating with a mobile terminal device, in accordance with an embodiment of the present teaching;

FIG. 2B and FIG. 2C illustrate structural diagrams of examples of an auxiliary operation device cooperating with a mobile terminal device, in accordance with alternate embodiments of the present teaching;

FIG. 2D illustrates a structural diagram of an example of an auxiliary operation device, in accordance with an embodiment of the present teaching;

FIG. 2E illustrates a structural diagram of an example of an auxiliary operation device, in accordance with an alternate embodiment of the present teaching;

FIG. 3A illustrates a circuit diagram of an example of an auxiliary operation device, in accordance with an embodiment of the present teaching;

FIG. 3B illustrates a circuit diagram of an example of an auxiliary operation device, in accordance with an alternate embodiment of the present teaching;

FIGS. 4A-4F illustrate connection diagrams of examples of the auxiliary operation device and a mobile terminal device, in accordance with embodiments of the present teaching; and

FIG. 5 illustrates a flowchart of an example of a method for using an auxiliary operation device to control a mobile terminal device, in accordance with an embodiment of the present teaching.

### DETAILED DESCRIPTION

Reference will now be made in detail to the embodiments of the present teaching. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims.

Furthermore, in the following detailed description of the present teaching, numerous specific details are set forth in order to provide a thorough understanding of the present teaching. However, it will be recognized by one of ordinary skill in the art that the present teaching may be practiced without these specific details. In other instances, well known methods, procedures, components, and circuits have not been described in detail as not to unnecessarily obscure aspects of the present teaching.

Embodiments according to the present teaching provide an auxiliary operation device operable for cooperating with a mobile terminal device and controlling the mobile terminal device. In one embodiment, the auxiliary operation device controls the mobile terminal device such as a cell phone to execute applications, e.g., a photography application. A user can operate, e.g., slide, press, or touch, one or more actionable areas on the auxiliary operation device. In one embodiment, the one or more actionable areas are touch screens or touch panels that can be operated by a user through sliding, pressing, or touching on the screens/panels. In another embodiment, the actionable areas are a set of buttons that can be operated by a user through pressing or sliding the buttons. The auxiliary operation device can detect which actionable area the user operates on. A control signal representing the detected operation can be transferred from the auxiliary operation device to the mobile terminal device. The control signal can cause the mobile terminal device to execute a function corresponding to the actionable area the user operates on. In one embodiment, the auxiliary operation device includes a supporting frame and a connecting element. The supporting frame can match or partly match the outline of the mobile terminal device. The connecting element can provide connection between the supporting frame and the mobile terminal device. Thus, the mobile terminal device can be structurally coupled to the auxiliary operation device. In addition, the coupling between the auxiliary operation device and the mobile terminal device may allow relative movement between the auxiliary operation device and the mobile terminal device. For example, when the connecting element is connected to the mobile terminal device, the supporting frame can rotate vertically or horizontally from 0 degree to 360 degrees, so that the user can adjust an angle between the auxiliary operation device and the mobile terminal device. By holding the supporting frame with the adjusted angle, the user can conveniently use the mobile terminal device for, e.g., self-portrait photography and lighting.

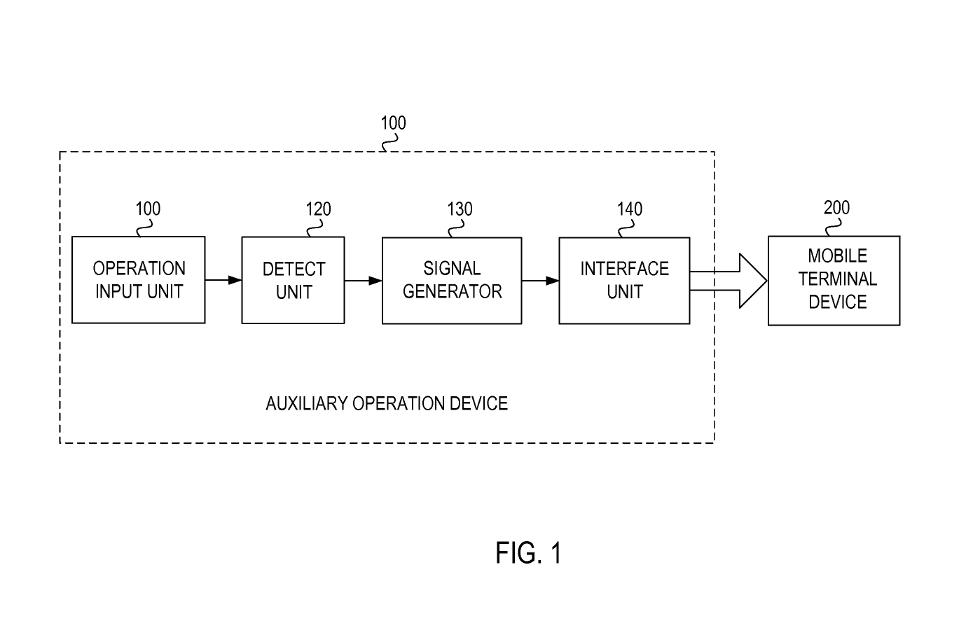

FIG. 1 illustrates a block diagram of an example of an auxiliary operation device 100, in accordance with an embodiment of the present teaching. As shown in FIG. 1, the auxiliary operation device 100 includes an operation input unit 110, a detecting unit 120, a signal generator 130, and an interface unit 140. The operation input unit 110 may include multiple actionable areas, e.g., a first button, a second button and a third button (not shown), that can be operated by a user. The detecting unit 120, coupled to the operation input unit 110, can detect an operation performed by the user on one of the actionable areas, and determine if the actionable area operated by the user is the first button, the second button or the third button, to provide a detected operation accordingly. The signal generator 130 is coupled to the detecting unit 120, and generates a control signal according to the detected operation from the detecting unit 120. The interface unit 140 is coupled to the signal generator 130 and can transfer the control signal generated by the signal generator 130 to a mobile terminal device 200.

The mobile terminal device 200 can be a cell phone, a personal digital assistant (PDA), a laptop, a tablet personal computer (tablet PC), or another smart mobile device. The control signal can include, e.g., an audio signal, a data signal, etc. The interface unit 140 can have an interface, e.g., an audio interface, a universal serial bus (USB) interface, etc., that is compatible with the form of the control signal, and connects to a corresponding interface of the mobile terminal device 200. In an example, if the control signal includes an audio signal, the interface unit 140 can be compatible to an audio interface, e.g., an earphone jack or another type of interface for inputting audio signals, of the mobile terminal device 200. The audio signal may be an analog or digital signal generated based on audio information. In another example, if the control signal includes a data signal, the interface unit 140 can be compatible to a data interface, such as a USB interface or the like, of the mobile terminal device 200. Compared with USB interfaces, circuits for processing audio signals have simpler structure and lower cost, and thus, the control signal is preferably, but not necessarily, to include an audio signal in some embodiments of the present teaching.

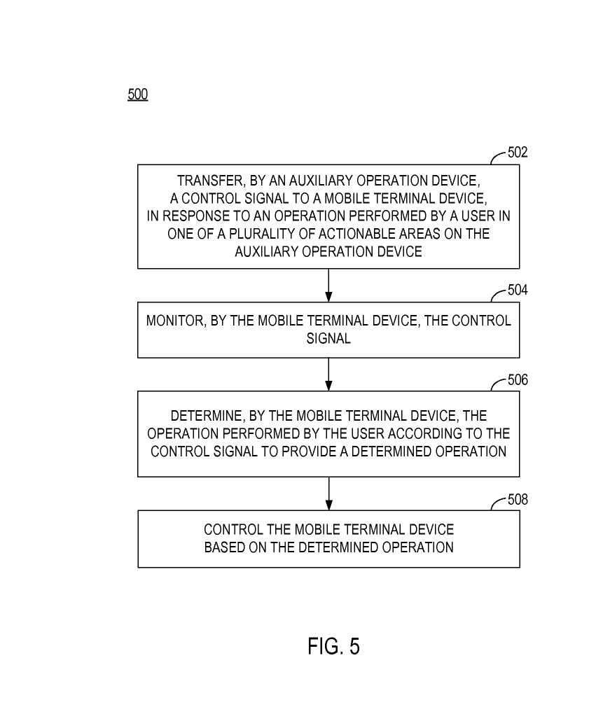

In one embodiment, the control signal includes an audio signal. In one exemplary embodiment, if the user operates on different buttons of the operation input unit 110, the detecting unit 120 can provide corresponding different detected operations, and the signal generator 130 can generate the audio signal at different frequencies according to the different detected operations. For example, if the user operates on the first, the second, or the third button, an audio signal at a frequency of, e.g., 1 KHz, 2 KHz, or 4 KHz, can be generated respectively. The audio signal can be input into an earphone jack or another kind of audio input interface of the mobile terminal device 200 via the interface unit 140. Upon receiving the control signal such as the audio signal, an application program in the mobile terminal device 200 can be used to analyze the audio signal, e.g., determine the frequency of the audio signal, to confirm if the button operated by the user is the first, the second, or the third button. A corresponding function, e.g., photography, lighting, answering a phone call, etc., can be executed according to the button operated by the user. More details on how the auxiliary operation device 100 cooperates with and controls the mobile terminal device 200 to execute the corresponding functions will be described with FIG. 5.

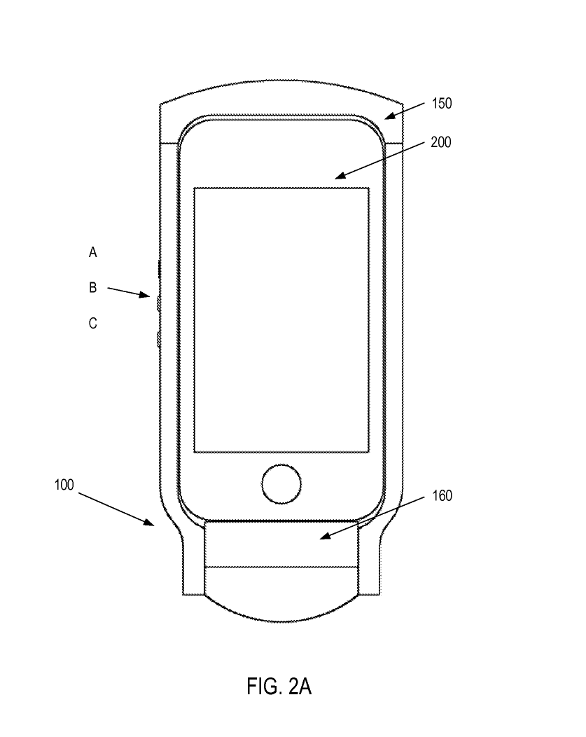

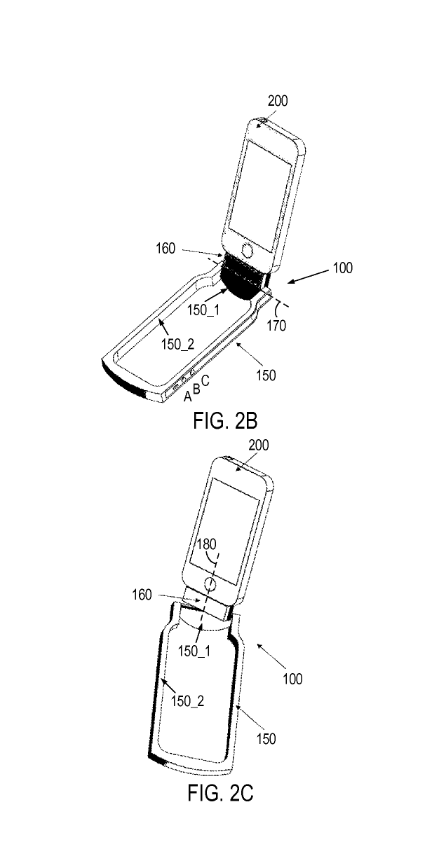

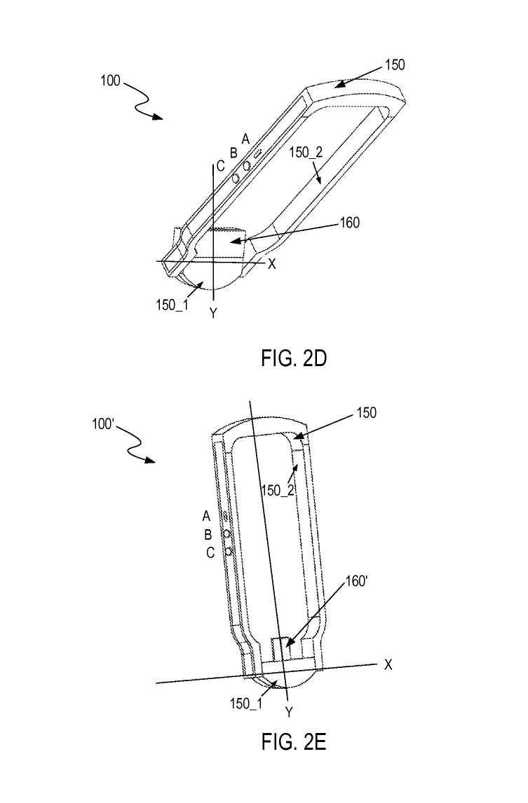

FIG. 2A illustrates a structural diagram of an example of the auxiliary operation device 100 cooperating with a mobile terminal device 200, in accordance with an embodiment of the present teaching. FIG. 2A is described in combination with FIG. 1. As shown in FIG. 2A, the auxiliary operation device 100 includes a supporting frame 150 and a connecting element 160. The supporting frame 150 can match the outline of the mobile terminal device 200. In the example of FIG. 2A, the supporting frame 150 surrounds the mobile terminal device 200.

In one scenario, “match the outline” means the shape of the supporting frame 150 fits the outline of the mobile terminal device 200 such that the left, right, top, and bottom side rims of the mobile terminal device 200 are surrounded by the supporting frame 150 and thus not exposed. In this scenario, some soft or elastic material can be used for the parts of the supporting frame 150 that may cover pre-existing actionable areas on the left, right, top, and bottom side rims of the mobile terminal device 200, such that a user can still operate directly on the mobile terminal device 200 covered by the supporting frame 150 when pressing or touching the soft or elastic material on the supporting frame 150.

In another scenario, “match the outline” means the shape of the supporting frame 150 fits the outline of the mobile terminal device 200 such that the left, right, top, and bottom side rims of the mobile terminal device 200 are surrounded by the supporting frame 150 and thus not exposed except the pre-existing actionable areas on the side rims of the mobile terminal device 200. In this scenario, there are openings in the supporting frame 150 corresponding to pre-existing actionable areas on the mobile terminal device 200, and the user can still operate directly on the mobile terminal device 200 covered by the supporting frame 150 when pressing or touching the pre-existing actionable areas through corresponding holes on the supporting frame 150.

In one embodiment, the supporting frame 150 can act as a protective case for the mobile terminal device 200 to protect the mobile terminal device 200 from damages caused by, e.g., the user dropping the mobile terminal device 200. For instance, the supporting frame 150 can be made of buffered or shock-resistant materials such as silica gel, except the parts covering pre-existing actionable areas on the mobile terminal device 200. Other materials that may form the supporting frame 150 include, but are not limited to, polycarbonate, polyethylene, natural or artificial leather, Kevlar, nylon, and/or the like.

The connecting element 160 is connected with the supporting frame 150 and provides connection between the supporting frame 150 and the mobile terminal device 200. One side/end of the connecting element 160 can be directly connected with the mobile terminal device 200 so that the supporting frame 150 surrounds the mobile terminal device 200 as shown in FIG. 2A. In one example, the above mentioned operation input unit 110 is positioned on the supporting frame 150, and the above mentioned detecting unit 120, signal generator 130, and interface unit 140 are positioned in or operably connected to the connecting element 160.

Additionally, in an alternative embodiment, the supporting frame 150 and the outline of the mobile terminal device 200 can be partly matched. As used herein, “partly matched” means the shape of the supporting frame 150 fits the outline of the mobile terminal device 200 such that part of one or more side rims of the left, right, top, and bottom side rims of the mobile terminal device 200 are surrounded by the supporting frame 150, and the other part of the side rims can be exposed. In an example, the right side and the top side of the supporting frame 150, where no button is located on the supporting frame 150 as shown in FIG. 2A, can be removed without influencing the basic functions of the auxiliary operation device 100. In this case, the size of the supporting frame 150 decreases, which may be desirable to some users. It will be recognized by one of ordinary skill in the art that the structures of the auxiliary operation devices in the embodiment of FIG. 2A and the following embodiments of FIG. 2B-FIG. 2E are used for illustrative purpose only, and are not intended to limit the present teaching. Auxiliary operation devices with other structures can also be included within the spirit and scope of the present teaching as long as the auxiliary operation devices can be used for controlling the mobile terminal device 200 and includes an operation input unit that a user can operate on so as to control the mobile terminal device 200.

FIG. 2B and FIG. 2C illustrate structural diagrams of examples of the auxiliary operation device 100 cooperating with the mobile terminal device 200, in accordance with embodiments of the present teaching. FIG. 2B and FIG. 2C are described in combination with FIG. 1 and FIG. 2A. It is to be noted that while the buttons' positions in FIG. 2B and FIG. 2C may not be identical as in FIG. 2A, the changes in position will not affect the operation performed on the buttons and the functions associated with the buttons. In FIG. 2A, the first, second and third buttons A, B and C (respectively) are located on the left side of the supporting frame 150; in FIG. 2B, the first, second and third buttons A, B and C are located on the right side of the supporting frame 150; and in FIG. 2C, the buttons A, B and C are located on the right side but are not visible because of the three-dimensional angle of the supporting frame 150 as shown.

In the example of FIG. 2B, the auxiliary operation device 100 is connected to the mobile terminal device 200. The supporting frame 150 includes a first portion 150_1 connected to the connecting element 160, and a second portion 150_2 connected to the first portion 150_1. The second portion 150_2 can be connected to the first portion 150_1 in a rotatable manner such that the second portion 150_2 can rotate from 0 degree to 360 degrees, taking the connecting shaft between the first and second portions 150_1 and 150_2 as an axis 170, and hereinafter, this will be referred to as a first rotation manner. Thus, the second portion 150_2 can rotate relative to the first portion 150_1 and the mobile terminal device 200 around an axis 170 in parallel with the connecting shaft between the portions 150_1 and 150_2. In the example of FIG. 2C, the first portion 150_1 of the supporting frame 150 and the connecting element 160 can also be connected in another rotatable manner such that the first portion 150_1 of the supporting frame 150 can rotate from 0 degree to 360 degrees taking a connecting direction (e.g., vertical to the connecting shaft between the first and second portions 150_1 and 150_2 of the supporting frame 150) of the connecting element 160 and the first portion 150_1 as an axis 180, and hereinafter, this will be referred to as a second rotation manner. Thus, through the connection of the first portion 150_1 and the connection element 160, the supporting frame 150 can rotate relative to the connecting element 160 and the mobile terminal device 200 around an axis 180 in parallel with the connecting direction at which the first portion 150_1 is connected to the connecting element 160. When rotating in the aforementioned first or second rotation manners, the supporting frame 150 can be secured relative to the mobile terminal device 200 after being rotated to any appropriate angle (from 0 degree to 360 degrees) according to the user's requirements. In one embodiment, the contacting part between the first and second portions 150_1 and 150_2 and the contacting part between the supporting frame 150 and the connecting element 160 can be made of materials with high friction coefficient. Thus, when the user rotates the supporting frame 150 to a certain position, the supporting frame 150 can stay in that position, in a similar way as a screen of a laptop that can stay at any angle rotated by the user.

In other words, in one embodiment, the contacting part between the first and second portions 150_1 and 150_2 can have a friction coefficient. Subsequent to rotating the second portion 150_2 around the axis 170 to an angle relative to the first portion 150_1, the second portion 150_2 can remain at that angle relative to the first portion 150_1 because of the friction coefficient. Similarly, in another embodiment, the contacting part between the first portion 150_1 and the connection element 160 (e.g., the contacting part between the supporting frame 150 and the connection element 160) can have a friction coefficient. Subsequent to rotating the first portion 150_1 (or the supporting frame 150) around the axis 180 to an angle (from 0 degree to 360 degrees) relative to the connection element 160, the first portion 150_1 (or the supporting frame 150) can remain at that angle relative to the connection element 160 because of the friction coefficient. In this case, when the user uses the mobile terminal device 200 to take a photo or provide lighting, the user can rotate and secure the supporting frame 150 to an angle convenient for photography or lighting. Thus a user can achieve any desired relative positions of the mobile terminal device 200 and the auxiliary operation device 100 by allowing a relative movement between them and securing their positions after desired movements. The relative movement may be controlled by an operation performed by the user on any of the actionable areas or buttons.

In an example, when a flashlight of the mobile terminal device 200 is turned on to provide the lighting function, if the supporting frame 150 is rotated to an appropriate angle to be placed in a required position (e.g., on a desktop), the mobile terminal device 200 can be used as a desk lamp. In another example, if the supporting frame 150 is rotated to an appropriate angle to be held by the user, the mobile terminal device 200 can be used as a light source. In yet another example, when the mobile terminal device 200 is used to take photos, the supporting frame 150 can be rotated to form an appropriate angle relative to the mobile terminal device 200, so as to avoid including a user's arm that holds the mobile terminal device 200, into the photos when the user is self-portrait-photography.

FIG. 2D illustrates a structural diagram of an example of an auxiliary operation device 100, in accordance with an embodiment of the present teaching. FIG. 2E illustrates a structural diagram of an example of an auxiliary operation device 100′, in accordance with another embodiment of the present teaching. The auxiliary operation devices 100 and 100′ have similar structures, except that the connecting elements 160 and 160′ connected with the supporting frame 150, as shown in FIG. 2D and FIG. 2E, have different shapes. As shown, the connecting element 160 in FIG. 2D is wider than the connecting element 160′ in FIG. 2E. As used herein, “wider” is used for illustrative purpose, and not intended to limit the present teaching. By way of example, an interface unit (not shown) of the connecting element 160 can be compatible to a dock interface of a cell phone such as, for example, iPhone5 (registered trademark), and the interface unit of the connecting element 160′ can be compatible to a regular data interface of another type of cell phone. It is to be noted that the axes x and y shown in FIG. 2D and FIG. 2E are axes for the aforementioned first and second rotation manners in FIG. 2C, respectively.

In one embodiment, the buttons A, B and C can be located on, e.g., the outside surface, of the supporting frame 150, and can be slide buttons, press buttons, or touch buttons, or a combination thereof. As used herein, “buttons” mean actionable areas that can be operated by a user through sliding, pressing, or touching. Thus, a user can control the mobile terminal device 200 to execute corresponding functions, e.g., taking a photo, answering a phone call, etc., by operating these buttons instead of operating the mobile terminal device 200 to invoke corresponding menu pages and to adjust settings on the menu pages. Therefore, the user's operation can be simplified. By way of example, in FIG. 2D, the button A can be a slide button and used for functions such as invoking a photography application and answering phone calls, and the buttons B and C can be push buttons and used for functions such as zooming in/out and controlling the flashlight. However, this disclosure is not so limited, and the buttons A, B and C can be defined with different functions according to the application environment or the user's requirements besides the aforementioned exemplified functions. Additionally, through FIG. 2A-2E, three buttons A, B and C are shown on the auxiliary operation devices for illustrative purpose only, and in another embodiment of this disclosure, more or less buttons can be included according to practical requirements. In some embodiments, the buttons may be configurable or programmable such that a user may define an operation that can be performed by the buttons.

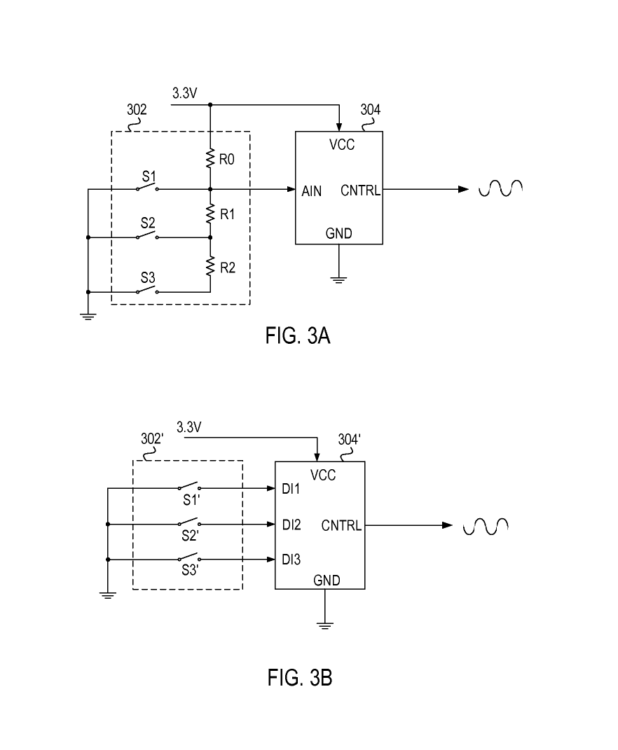

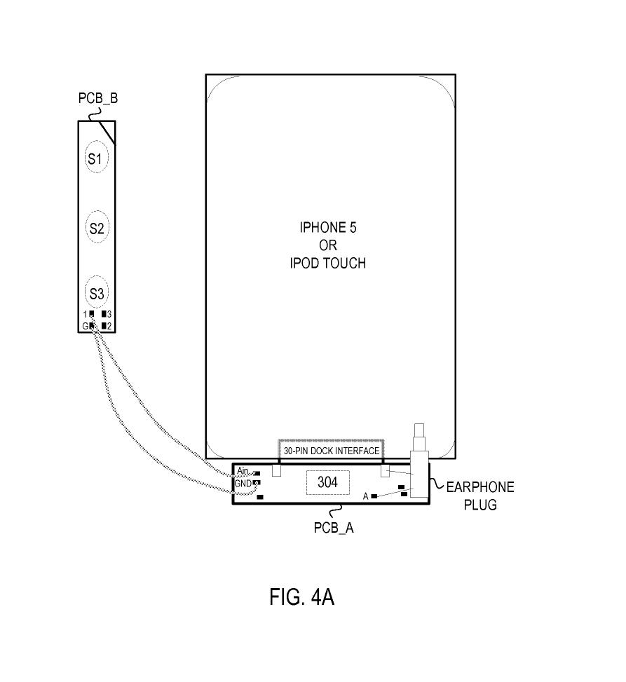

FIG. 3A and FIG. 3B illustrate circuit diagrams of examples of an operation input unit 110, a detecting unit 120, and a signal generator 130 of the auxiliary operation device 100, in accordance with an embodiment of the present teaching. FIG. 3A and FIG. 3B are described in combination with FIG. 1 and FIG. 2A-FIG. 2E. In the embodiment of FIG. 3A, functions of the operation input unit 110 can be realized by an input circuit 302 including a first set of switches S1-S3 and a set of resistors R0-R2, and functions of the detecting unit 120 and the signal generator 130 can be realized by a control circuit 304. In the embodiment of FIG. 3B, functions of the operation input unit 110 can be realized by an input circuit 302′ including a second set of switches S1′-S3′, and functions of the detecting unit 120 and the signal generator 130 can be realized by a control circuit 304′. In one example, the control circuits 304 and 304′ can include integrated control circuitry such as MCU (e.g., Micro Control Unit PIC10F220 provided by Microchip Technology Inc.)

As shown in FIG. 3A, the input circuit 302 includes switches S1, S2 and S3 and resistors R0, R1 and R2 coupled to the switches S1-S3 respectively. The switches S1, S2 and S3 correspond to the aforementioned buttons A, B and C respectively. The resistors R0, R1 and R2 are coupled in series, where a terminal of the resistor R0 is coupled to a power source VCC, e.g., having a voltage level 3.3V, and a terminal of the resistor R2 is grounded via the switch S3. The switch S1 is coupled between ground and a common node between the resistors R0 and R1, and the switch S2 is coupled between ground and a common node between the resistors R1 and R2. When a user operates, e.g., slides, presses, or touches, one of the buttons (A, B or C), a corresponding switch (S1, S2 or S3) is turned on and thus a terminal of a corresponding resistor (R0, R1 or R2) is grounded. In this case, the common node between the resistors R0 and R1 can obtain a corresponding divided voltage signal. The divided voltage signal is then input to an analog signal input terminal AlN of the control circuit 304, e.g., an MCU.

In a first scenario, when none of the buttons A, B and C is slid/pressed/touched by the user, the switches S1, S2 and S3 are all turned off, and thus the divided voltage signal at the common node between the resistors R0 and R1 is substantially equal to the voltage level of the voltage source VCC, e.g., 3.3V. As used herein, “substantially equal to” means the voltage level of the divided voltage signal at the common node can be different from the voltage level of the voltage source VCC, so long as the differences are in a range that can be neglected.

In a second scenario, when the user operates the button A, only the switch S1 is turned on, so that the resistor R0 is coupled between the power source VCC and ground. Therefore the voltage level of the divided voltage signal at the common node between the resistors R0 and R1 is substantially zero. Thus, when the button A is operated, the input terminal AlN receives a voltage of, e.g., zero volts, from ground via the switch S1.

In a third scenario, when the user operates the button B, only the switch S2 is turned on, so that the series-coupled resistors R0 and R1 are coupled between the power source VCC and ground. Therefore the divided voltage signal at the common node between the resistors R0 and R1 can be calculated by [R1/(R0+R1)]*VCC. Thus, when the button B is operated, the input terminal AlN receives a voltage signal, e.g., at level [R1/(R0+R1)]*VCC.

In a fourth scenario, when the user operates the button C, only the switch S3 is turned on, so that the series-coupled resistors R0, R1 and R2 are coupled between the power source VCC and ground. Therefore the voltage signal at the common node between the resistors R0 and R1 is [(R1+R2)/(R0+R1+R2)]*VCC. Thus, when the button C is operated, the input terminal AlN receives a voltage signal, e.g., at level [(R1+R2)/(R0+R1+R2)]*VCC.

For example, if the resistors R0, R1 and R2 have the same resistance value and the voltage level of the voltage source VCC is, e.g., 3.3V, then by sliding/pressing/touching the button A, B, or C, the analog signal input terminal AlN of the control circuit 304 can obtain a divided voltage signal substantially at 0V, 1.65V, or 2.2V, respectively.

Then, the control circuit 304, e.g., the MCU, converts the divided voltage signal to a digital signal to be compared with a predetermined threshold, so as to determine if the user has slid/pressed/touched a button and which button among the buttons A, B and C that the user has operated on. In one embodiment, four voltage sections/ranges are set between the voltage levels 0V and 3.3V, such that each voltage of the 0V, 1.65V, 2.2V, and 3.3V is within a corresponding one of the four voltage sections/ranges. For example, if the voltage level of the divided voltage signal falls into the last section having the highest voltage, which indicates that the divided voltage signal is close to 3.3V, then it is determined that no button is slid/pressed/touched by the user. If the divided voltage signal falls into one of the other three voltage sections/ranges, which indicates that the divided voltage signal is approximately at 0V, 1.65V or 2.2V, then it is determined that the user has slid/pressed/touched a corresponding button A, B or C.

Moreover, in another embodiment, the resistors R0, R1 and R2 can have different resistance values. Accordingly, different voltage levels can be obtained at the analog signal input terminal AlN, and thus the four voltage sections can be set according to these different voltage levels.

If it is determined that the user has operated on, e.g., slid/pressed/touched, a certain button (e.g., A, B or C), the control circuit 304 (e.g., the MCU) can generate a corresponding control signal at an output terminal CNTRL. By way of example, the MCU can generate the control signal, e.g., an audio signal at a frequency of 1 KHz (Kilo Hertz), 2 KHz, or 4 KHz, in accordance with a button A, B or C operated by the user. In various embodiments, the control signal can be a sinusoidal signal, a square-wave signal, or the like.

FIG. 3B shows an alternative embodiment, in which the input circuit 302′ includes switches S1′, S2′ and S3′ connected directly to digital input terminals DI1, DI2 and DI3 of the control circuit 304′, respectively. When the user slides/presses/touches a certain button, a corresponding switch S1′, S2′ or S3′ is turned on, and a corresponding digital input terminal is grounded. As a result, the control circuit 304′, e.g., an MCU, can determine which button among the buttons A, B and C has been slid/pressed/touched by identifying which digital input terminal is at zero volts, and then the control circuit 304′ can generate a corresponding control signal.

The control signal generated in the embodiment of FIG. 3A or FIG. 3B is input to a corresponding interface of the mobile terminal device 200 via the interface unit 140, such that the mobile terminal device 200 can perform a corresponding function according to the control signal. In one embodiment, the control signal includes an audio signal which is input into an audio interface of the mobile terminal device 200 via the interface unit 140. In another embodiment, the control signal includes a data signal which is transferred to a data interface such as a USB interface of the mobile terminal device 200. Although the control circuits 304 and 304′ are embodied as an MCU in the above description, this disclosure is not so limited. The control circuits 304 and 304′ can also include separated circuits for performing the functions of the detecting unit 120 and the signal generator 130 in FIG. 1, respectively.

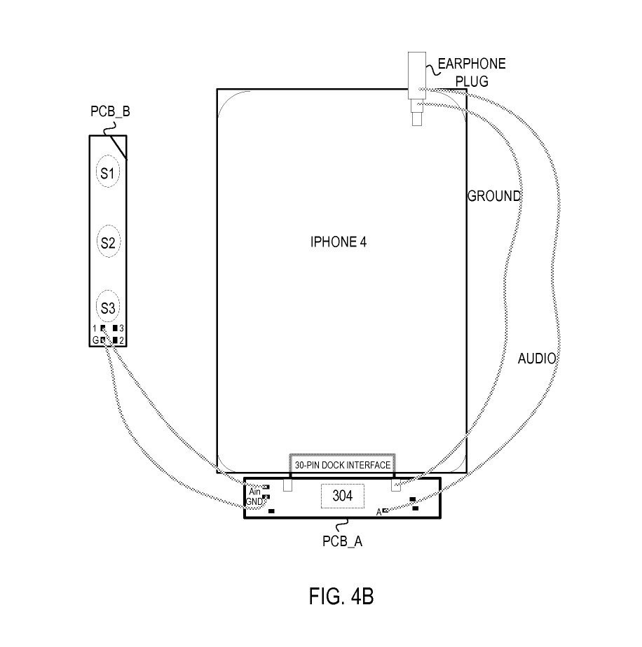

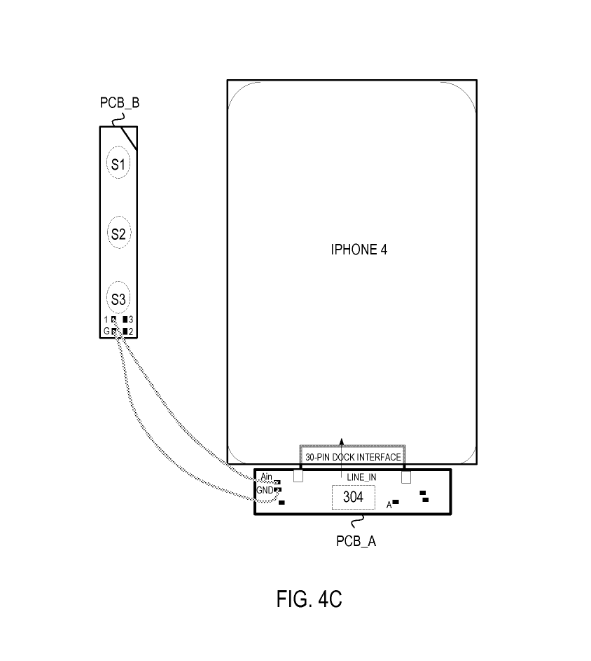

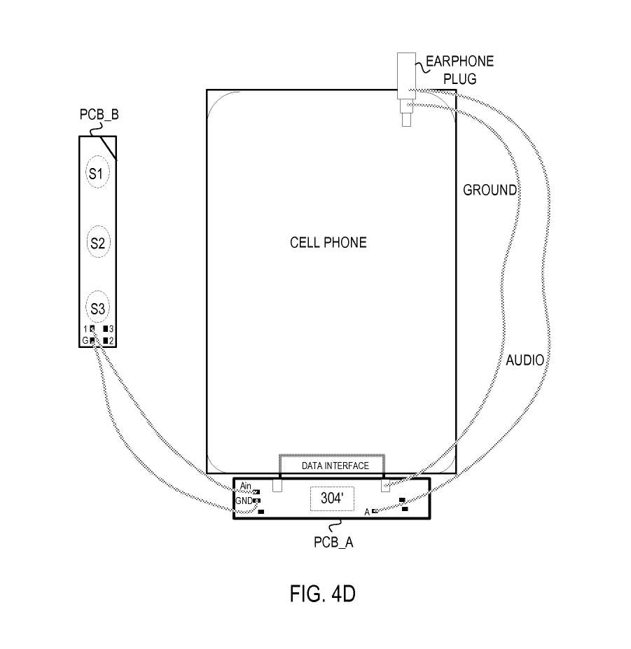

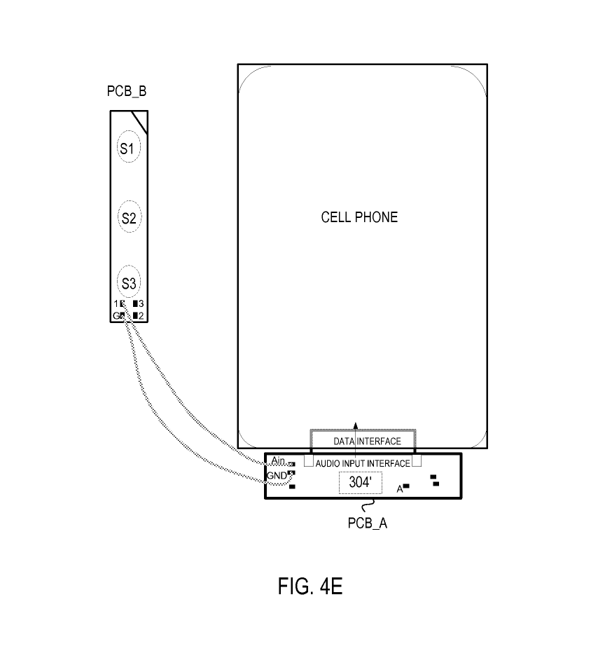

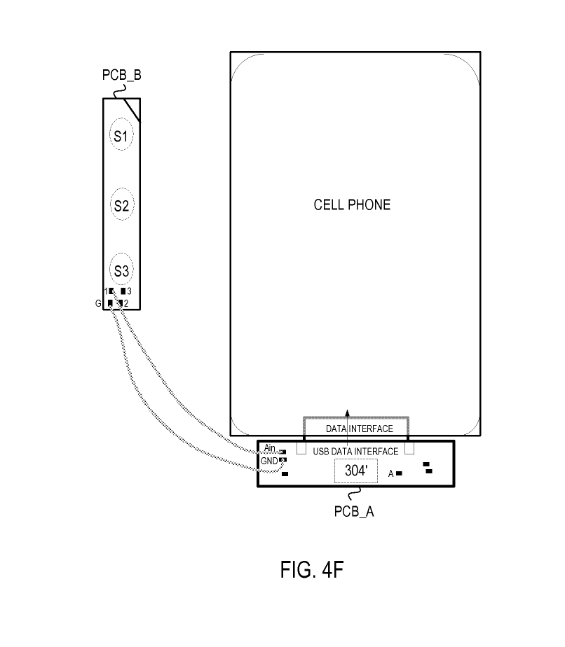

FIG. 4A, FIG. 4B and FIG. 4C illustrate connection diagrams of examples of the auxiliary operation device in FIG. 3A and a mobile terminal device, in accordance with embodiments of the present teaching. Examples of configuration and connection relations between the auxiliary operation device in FIG. 3A and a mobile terminal device will be described in combination with FIG. 1, FIG. 2A-2E, FIG. 3A, FIG. 4A, FIG. 4B, and FIG. 4C. In the following description regarding FIG. 4A, FIG. 4B, and FIG. 4C, the mobile terminal device is exemplified as a cell phone, e.g., iPhone4 (registered trademark), iPhone5 (registered trademark), or another type of electronic device such as iPod touch (registered trademark), etc., produced by Apple Inc.

As shown in FIG. 4A, the mobile terminal device can be a cell phone such as iPhone5 or an electronic device such as iPod touch, and the auxiliary operation device can include the circuitry, such as the input circuit 302 and the control circuit 304, shown in FIG. 3A. The control circuit 304, e.g., an MCU, in FIG. 3A can be located on a first printed circuit board PCB_A in FIG. 4A, for performing the functions of the detecting unit 120 and the signal generator 130 in FIG. 1. The input circuit 302 in FIG. 3A can be located on a second printed circuit board PCB_B in FIG. 4A, for performing the functions of the operation input unit 110 in FIG. 1. In one embodiment, the first printed circuit board PCB_A can be embedded in the connecting element 160 shown in FIG. 2A-FIG. 2E, and the second printed circuit board PCB_B can be embedded in the supporting frame 150 shown in FIG. 2A-FIG. 2E. The first and second printed circuit boards PCB_A and PCB_B can be connected via a set of connecting wires. One of the connecting wires connects a common ground terminal G of the switches S1, S2 and S3 on the second printed circuit board PCB_B to a ground terminal GND of the MCU on the first printed circuit board PCB_A. One of the connecting wire transfers a voltage signal obtained at the common node between the resistors R0 and R1 from the second printed circuit board PCB_B to an analog signal input terminal AlN of the MCU on the first printed circuit board PCB_A. The connecting wires may further include a power supply wire (not shown) to provide a power supply voltage, e.g., the 3.3V shown in FIG. 3A, from the mobile terminal device to the input circuit 302 on the second printed circuit board PCB_B.

When the MCU generates a control signal at an output terminal CNTRL of the MCU, the control signal can be input into the earphone jack of the mobile terminal device via an earphone plug installed on the first printed circuit board PCB_A. In particular, as shown in FIG. 4A, a part of the earphone plug is located on the first printed circuit board PCB_A, coupled to the ground terminal of the MCU, and configured for receiving the control signal generated by the MCU. The other part of the earphone plug is plugged into the earphone jack of the mobile terminal device. In the embodiment of FIG. 4A, on the first printed circuit board PCB_A, the ground terminal connected with the earphone plug is different from the ground terminal GND connected with the second printed circuit board PCB_B. However, this disclosure is not so limited, and in another embodiment, those two ground terminals can be a common ground terminal on the first printed circuit board PCB_A. The earphone plug can transfer the control signal generated by the MCU to the mobile terminal device.

Additionally, the MCU can be connected with a 30-pin dock interface (not shown) of the mobile terminal device via a 30-pin dock interface on the auxiliary operation device. As shown, the dock interfaces of the auxiliary operation device and the mobile terminal device are overlapped while connected, so that only the dock interface of the auxiliary operation device can be presented, and the dock interface of the mobile terminal device cannot be shown in FIG. 4A. In this embodiment, the 30-pin dock interface of the auxiliary operation device is not used to transfer the control signal, but to transfer power from the mobile terminal device to the MCU. Therefore, the 30-pin dock interface and the earphone plug of the auxiliary operation device perform the functions of the interface unit 140.

In the embodiment shown in FIG. 4B, the earphone jack is located on the top side of the mobile terminal device, e.g., a cell phone iPhone4, and can be used for transferring data. The embodiment in FIG. 4B is similar to the embodiment in FIG. 4A except that, the earphone plug in FIG. 4B is connected to the MCU via external connecting wires. The external connecting wires can be implanted inside the supporting frame 150, or be exposed outside.

In the embodiment shown in FIG. 4C, the earphone jack is located on the top side of the mobile terminal device, e.g., a cell phone iPhone4, and may not be used for transferring data. In that case, a line_in interface in the dock interface of the mobile terminal device can be used to input the control signal (e.g., including an audio signal) into the mobile terminal device, and thus the external connecting wires mentioned in relation to FIG. 4B can be omitted. In the embodiment in FIG. 4C, the control signal generated by the MCU can be input directly into a line_in interface (not shown) in the 30-pin dock interface of the mobile terminal device via the line_in interface in the 30-pin dock interface of the auxiliary operation device. Therefore, the 30-pin dock interface of the auxiliary operation device is used to perform the functions of the interface unit 140.

FIG. 4D, FIG. 4E and FIG. 4F illustrate connection diagrams of examples of the auxiliary operation device in FIG. 3A and a mobile terminal device, in accordance with embodiments of the present teaching. The structure shown in FIG. 4D is similar to the structure shown in FIG. 4B, and the structure shown in FIG. 4E is similar to the structure shown in FIG. 4C, except that in FIG. 4D and FIG. 4E, the mobile terminal device can be a cell phone without a dock interface and the auxiliary operation device can have a regular data interface instead of a dock interface.

As illustrated in FIG. 4A-FIG. 4E, the control signal includes an audio signal. While in another embodiment shown in FIG. 4F, the control signal can include a data signal transferred using, for example, a USB interface. The structure shown in FIG. 4F is similar to the structure shown in FIG. 4E, except that in FIG. 4F, the control signal generated by the MCU is input into the cell phone via a USB data port interface.

It should be understood that, although the mobile terminal device described above is embodied as a cell phone such as an iPhone4, iPhone5, or an electronic device such as iPod touch, this disclosure is not so limited, and in another embodiment, the mobile terminal device can be another type of electronic device, e.g., a tablet PC, etc. The implementation of the embodiments using the structures in FIG. 4A-FIG. 4F to control such a mobile terminal device, e.g., a tablet PC, is similar to the implementation of the aforementioned embodiments for controlling, e.g., a cell phone.

FIG. 5 illustrates a flowchart 500 of an example of a method for using an auxiliary operation device to control a mobile terminal device, in accordance with an embodiment of the present teaching. FIG. 5 will be described in combination with FIG. 1, FIG. 2A-2E, FIG. 3A-3B and FIG. 4A-4F. The auxiliary operation device can be, e.g., the auxiliary operation devices 100 and 100′ in FIG. 1, FIG. 2A-2E, or their alternatives, and can include, e.g., the input circuit 302 and the control circuit 304 in FIG. 3A, or the input circuit 302′ and the control circuit 304′ in FIG. 3B. However, this disclosure is not so limited, and the auxiliary operation device can be another type of device as long as it includes one or more actionable areas, e.g. buttons that can be operated by a user, and generates a control signal based on the user's operation performed on one of the buttons, and transfers the control signal to control a mobile terminal device.

At 502, the auxiliary operation device, e.g., 100 or 100′, transfers a control signal to the mobile terminal device, e.g., a cell phone or an electronic device, in response to an operation performed by a user on one of multiple buttons on the auxiliary operation device.

At 504, the mobile terminal device monitors the control signal. In one embodiment, the mobile terminal device (e.g., a cell phone) can use a control signal monitor to monitor the control signal. The control signal can include an audio signal or a data signal. Accordingly, the control signal monitor in the mobile terminal device can monitor the control signal received at an audio interface (e.g., an earphone jack or another type of audio input interface) or a data interface (e.g., a USB interface) of the mobile terminal device.

At 506, the mobile terminal device determines which button among the multiple buttons is operated, e.g., slid, pressed, or touched, by the user according to the control signal. In one embodiment, the mobile terminal device can determine if the button is a first button (e.g., the button A), a second button (e.g., the button B), or a third button (e.g., the button C). The control signal monitor in the mobile terminal device can be used to determine which button is slid/pressed/touched by the user according to the control signal. By way of example, if the control signal includes an audio signal, the control signal monitor can determine which button is operated by the user according to a parameter (e.g., frequency, amplitude, etc.) of the audio signal. For example, by analyzing the frequency of the audio signal, and by looking up a pre-stored table of corresponding relations between frequencies and the buttons, it can be determined whether the button operated by the user is the first button A, the second button B, or the third button C.

At 508, the mobile terminal device is controlled based on the operation determined at 506. In addition, the mobile terminal device can be controlled through the operation performed by the user on the button, e.g., button A, B or C, located on the auxiliary operation device. In other words, the user does not have to operate directly on the mobile terminal device to invoke, e.g., application programs, in the mobile terminal device.

Processes in 502-508 are for illustrative purpose only. This disclosure is not so limited, and more processes can be included in the method 500. By way of example, more steps can be performed between 506 and 508, such as using an incoming call monitor to monitor if the mobile terminal device has an incoming call (not shown). In general, phone calls possess the highest priority for users. When the incoming call monitor monitors that there is an incoming call, the buttons on the auxiliary operation device can be assigned with respective functions such as answering the call and rejecting the call, and the user can answer or reject the incoming call by operating, e.g., sliding, pressing, or touching, the corresponding button on the auxiliary operation device. By way of example, if the incoming call monitor detects that there is an incoming call, and if the control signal monitor detects a control signal from the auxiliary operation device and determines that button A is operated by the user according to the frequency of the control signal, then the incoming call can be answered; and if the control signal monitor determines that button B is operated by the user according to the frequency of the control signal, then the incoming call can be rejected.

When no incoming call is detected by the incoming call monitor, the buttons can be allocated with functions related to photography by the corresponding application program(s) of the mobile terminal device, and the mobile terminal device can be enabled to execute applications relevant to photography according to the buttons operated by the user. By way of example, the application programs can invoke a photography program monitor, and set a flag bit that can be monitored by the photography program monitor to indicate if the photography program is started up. The initial value of the flag bit is “0”. During a time period while no incoming call is received by the mobile terminal device, if the control signal monitor detects a control signal representing the button A for the first time, then the control signal can be considered to indicate starting up the photography program, and the flag bit is set to be “1”. Otherwise, if no control signal is detected, the flag bit is maintained to be “0”. The photography program monitor can determine whether the photography program is started up according to the flag bit.

In one embodiment, on one hand, if the photography program monitor determines that the photography program has been started up, e.g., the flag bit is “1,” the application programs can allocate the buttons A, B and C with functions, e.g., taking photos, zooming in, and zooming out, respectively. On the other hand, if the photography program monitor determines that the photography program has not been started up, the application programs can allocate the buttons A, B and C with functions, e.g., starting up the photography program, turning on the flashlight, and turning off the flashlight, respectively.

By way of example, in a situation when the incoming call monitor detects that the mobile terminal device does not receive any incoming call, and if the control signal monitor detects a control signal from the auxiliary operation device, the photography program monitor determines if the photography program in the mobile terminal device has been started up. On one hand, if the photography program monitor determines that the photography program has been started up, the application programs can allocate the buttons A, B and C with functions, e.g., taking photos, zooming in, and zooming out, respectively. In particular, if the control signal monitor determines, according to the control signal, that the user operates on the button A, the mobile terminal device can take a photo directly; and if the control signal monitor determines that the user operates on the button B or button C, the mobile terminal device can perform zooming in or zooming out in the photography program accordingly. On the other hand, if the photography program monitor determines that the photography program has not been started up, the application programs can allocate the buttons A, B and C with functions, e.g., starting up the photography program, turning on the flashlight, and turning off the flashlight, respectively. In particular, if the control signal monitor determines that the user operates on the button A, the photography program can be started up; and if the control signal monitor determines that the user operates on the button B or button C, the flashlight can be turned on or turned off accordingly. Therefore, the mobile terminal device can be used as an electric torch or a desk lamp.

In one embodiment, if the mobile terminal device does not have a phone call function, or if the user does not set the phone call function with a higher priority than photography, then the abovementioned steps related with monitoring incoming call can be omitted, and the application related with photography can be executed directly.

Embodiments according to the present teaching provide auxiliary operation devices and methods for using an auxiliary operation device to control a mobile terminal device. Users can control the common functions of the mobile terminal device, e.g., cell phone, tablet PC, etc., by operating actionable areas or buttons located on the auxiliary operation device, which makes the controlling simple and convenient. In one embodiment, when a user is using the mobile terminal device for self-portrait-photography, the user can adjust an angle between the auxiliary operation device and the mobile terminal device and hold the auxiliary operation device to directly operate, e.g., slide, press, or touch, the buttons on the auxiliary operation device, so as to take photos, e.g., self-portrait-photograph. This avoids including the user's hand or arm in the photos, and the user can use the mobile terminal device conveniently to self-portrait-photograph.

While the foregoing description and drawings represent embodiments of the present teaching, it will be understood that various additions, modifications and substitutions may be made therein without departing from the spirit and scope of the principles of the present teaching as defined in the accompanying claims. One skilled in the art will appreciate that the teaching may be used with many modifications of form, structure, arrangement, proportions, materials, elements, and components and otherwise, used in the practice of the teaching, which are particularly adapted to specific environments and operative requirements without departing from the principles of the present teaching. The presently disclosed embodiments are therefore to be considered in all respects as illustrative and not restrictive, the scope of the teaching being indicated by the appended claims and their legal equivalents, and not limited to the foregoing description.

We claim:

1. An apparatus comprising:
an operation input unit comprising a plurality of actionable areas configured to be operated by a user;
a detecting unit, coupled to the operation input unit, and configured to detect an operation performed by the user in one of the actionable areas to provide a detected operation;
a signal generator, coupled to the detecting unit, and configured to generate a control signal according to the detected operation; and
an interface unit, coupled to the signal generator, and configured to transfer the control signal to a mobile terminal device that is structurally coupled to the auxiliary operation device.

2. The apparatus of claim 1, further comprising:
a supporting frame that at least partly matches an outline of the mobile terminal device; and
a connecting element, coupled to the supporting frame, and configured to provide the coupling between the apparatus and the mobile terminal device, wherein the interface unit is operably connected to the connecting element.

3. The apparatus of claim 2, wherein existing actionable areas on the mobile terminal device are directly operable by the user, when the mobile terminal device is covered by the supporting frame.

4. The apparatus of claim 2, wherein the operation input unit is positioned on the supporting frame, and the detecting unit and the signal generator are positioned in the connecting element.

5. The apparatus of claim 2, wherein the supporting frame comprises a first portion connected to the connecting element and comprises a second portion connected to the first portion, and wherein the second portion is configured to be able to rotate relative to the first portion around an axis in parallel with a connecting shaft between the first and second portions.

6. The apparatus of claim 5, wherein the supporting frame is configured to be able to rotate relative to the connecting element around an axis in parallel with a direction at which the first portion is connected to the connection element.

7. The apparatus of claim 5, wherein a contacting portion between the first and second portions has a friction coefficient, and wherein, subsequent to rotating the second portion around the axis to an angle relative to the first portion, the second portion is held at the angle relative to the first portion based on the friction coefficient.

8. The apparatus of claim 2, wherein the actionable areas are located on an outside surface of the supporting frame.

9. The apparatus of claim 2, wherein the actionable areas comprise a button selected from the group consisting of a slide button, a press button, and a touch button.

10. The apparatus of claim 2, wherein each of the actionable areas comprises a different function.

11. The apparatus of claim 1, wherein the plurality of actionable areas include at least one of a screen, a panel, and a programmable button.

12. The apparatus of claim 1, wherein the control signal comprises an audio signal, and the interface unit is compatible to an audio interface of the mobile terminal device.

13. The apparatus of claim 12, wherein the signal generator generates the audio signal at different frequencies according to different detected operations from the detecting unit.

14. The apparatus of claim 1, wherein the control signal comprises a data signal, and the interface unit is compatible to a data interface of the mobile terminal device.

15. The apparatus of claim 1, wherein the coupling between the apparatus and the mobile terminal device allows relative movement between the apparatus and the mobile terminal device.

16. The apparatus of claim 15, wherein the relative movement is controlled at least by an operation performed by the user in any of the actionable areas.

17. A method for using an apparatus to control a mobile terminal device, the method comprising:
transferring, by the apparatus, a control signal to the mobile terminal device, in response to an operation performed by a user on one of a plurality of actionable areas on the apparatus;
monitoring the control signal by the mobile terminal device;
determining, by the mobile terminal device, the operation performed by the user according to the control signal to provide a determined operation; and
controlling, by the apparatus, the mobile terminal device based on the determined operation, wherein the mobile terminal device is structurally coupled to the apparatus.

18. The method of claim 17, wherein the monitoring of the control signal by the mobile terminal device comprises monitoring an audio signal from an audio interface of the mobile terminal device, and wherein the control signal comprises the audio signal.

19. The method of claim 17, wherein determining the operation comprises determining the actionable area operated by the user from the plurality of actionable areas according to a frequency of the control signal.

20. The method of claim 17, wherein the monitoring of the control signal by the mobile terminal device comprises monitoring a data signal from a data interface of the mobile terminal device, and wherein the control signal comprises the data signal.

21. The method of claim 17, further comprising monitoring if the mobile terminal device receives an incoming call, wherein the mobile terminal device has a phone call function.

22. The method of claim 21, further comprising answering the incoming call or rejecting the incoming call according to the determined operation if the incoming call is received.

23. The method of claim 21, further comprising enabling the mobile terminal device to execute a photography application according to the determined operation if no incoming call is received.

24. The method of claim 23, wherein the enabling of the mobile terminal device to execute the photography application comprises:
determining whether a photography program has been launched when no incoming call is received; and
determining whether the control signal is detected.

25. The method of claim 17, further comprising enabling the mobile terminal device to execute a photography application according to the determined operation.

26. The method of claim 25, wherein the enabling of the mobile terminal device to execute the photography application comprises determining whether a photography program has been launched if the control signal is detected.

27. The method of claim 26, further comprising enabling the mobile terminal device to take a photo if the determined operation is associated with a first actionable area and if the photography program has been started up.

28. The method of claim 26, further comprising enabling the mobile terminal device to perform zooming in or zooming out in the photography program respectively, if the determined operation is associated with a second actionable area or a third actionable area and if the photography program has been launched.

29. The method of claim 26, further comprising launching the photography program if the determined operation is associated with a first button and if the photography program has not been launched.

30. The method of claim 26, further comprising turning on or turning off a flashlight of the mobile terminal device respectively, if the determined operation is associated with a second actionable area or a third actionable area and if the photography program is not launched.
